(19) United States
(12) Patent Application Publication
(10) Pub. No.: US 2025/0045011 A1
(43) Pub. Date: Feb. 6, 2025

(54) METHOD AND APPARATUS FOR AUDIO PROCESSING IN MULTI-VIEW MODE

(71) Applicant: Samsung Electronics Co., Ltd., Suwon-si (KR)

(72) Inventors: Xianghu CHEN, Nanjing (CN); Zuolong WANG, Nanjing (CN); Yong ZHANG, Nanjing (CN)

(21) Appl. No.: 18/637,804

(22) Filed: Apr. 17, 2024

Related U.S. Application Data
(63) Continuation of application No. PCT/KR2024/004919, filed on Apr. 12, 2024.

(30) Foreign Application Priority Data
Aug. 1, 2023 (CN) 202310957638.3

(51) Int. Cl. G06F 3/16

(52) U.S. Cl. CPC G06F 3/165; G06F 3/162

(57) ABSTRACT

A method and an apparatus for audio processing in a multi-view mode are provided. triggering, when a preset audio output adjusting event occurs, corresponding views to perform audio output by using matching sound output devices based on a policy that a first application uses a real sound output device and a non-first application uses a virtual sound output device, wherein the audio output adjusting event is an event causing the sound output devices used by the views to not match the policy, when a mixing mode is off, the first application is an application currently in an audio focus, and when the mixing mode is on, the first application is an application currently participating in mixing.

### CROSS-REFERENCE TO RELATED APPLICATION(S)

This application is a continuation application, claiming priority under § 365 (c), of an International application No. PCT/KR2024/004919, filed on Apr. 12, 2024, which is based on and claims the benefit of a Chinese patent application number 202310957638.3, filed on Aug. 1, 2023, in the Chinese Intellectual Property Office, the disclosure of which is incorporated by reference herein in its entirety.

### BACKGROUND

### 1. Field

The disclosure relates to computer application technologies. More particularly, the disclosure relates to a method and an apparatus for audio processing in a multi-view mode.

### 2. Description of Related Art

With the development of smart televisions, multi-view has gradually become a consumer's favorite function. A plurality of sources may be displayed simultaneously in the multi-view mode, and users are allowed to enjoy various television-related contents on a large screen.

In the process of implementing the disclosure, the inventors have found that the existing common audio processing schemes are prone to the problem of an audio resource conflict when entering the multi-view mode, and the specific reasons are analyzed as follows:

In existing audio processing schemes, a sound output device is usually bound to a certain presentation area in advance. Then, after entering the multi-view mode, whether the corresponding view may output sound is determined according to whether the presentation area used by each view is bound to the sound output device. In this way, the problem that newly started non-focus views preempt audio resources of focus views is easily caused.

FIG. 1 illustrates a diagram of an audio resource conflict according to the related art.

Referring to FIG. 1, in a single-view mode, application App1 occupies an audio resource. When application App2 is started and enters a multi-view mode, App2 enables audio since an occupied area is configured as an area using a sound output device. Therefore, App2 preempts the audio resource of the focus view App1. However, in this case, a user does not expect App2 to enable the audio, but rather expects the focus view App1 to continue to occupy the audio resource, so that the problem of an audio resource conflict may be caused.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a method and apparatus for audio processing in a multi-view mode, which can realize the independent output of focus App audios in a multi-view mode, thereby avoiding an audio resource conflict.

Additional aspects will be set forth in part in the description which follows and, in part, will be apparent from the description, or may be learned by practice of the presented embodiments.

In accordance with an aspect of the disclosure, a method for audio processing in a multi-view mode is provided. The method includes triggering, when a preset audio output adjusting event occurs, corresponding views to perform audio output by using matching sound output devices based on a policy that a first application uses a real sound output device and a non-first application uses a virtual sound output device, wherein the audio output adjusting event is an event causing the sound output devices used by the views to not match the policy, when a mixing mode is off, the first application is an application currently in an audio focus, and when the mixing mode is on, the first application is an application currently participating in mixing.

In accordance with another aspect of the disclosure, an apparatus for audio processing in a multi-view mode is provided. The apparatus includes an audio controller module, configured to trigger, when a preset audio output adjusting event occurs, corresponding views to perform audio output by using matching sound output devices based on a policy that a first application uses a real sound output device and a non-first application uses a virtual sound output device, wherein the audio output adjusting event is an event causing the sound output devices used by the views to not match the policy, when a mixing mode is off, the first application is an application currently in an audio focus, and when the mixing mode is on, the first application is an application currently participating in mixing.

In accordance with another aspect of the disclosure, an electronic device for audio processing in a multi-view mode is provided. The electronic device includes memory storing one or more computer programs, and one or more processors communicatively coupled to the memory, wherein the one or more computer programs include computer-executable instructions that, when executed by the one or more processors cause the electronic device to trigger, when a preset audio output adjusting event occurs, corresponding views to perform audio output by using matching audio output devices based on a policy that a first application uses a real audio output device and a non-first application uses a virtual audio output device, and wherein the audio output adjusting event is an event causing the audio output devices used by the views to not match the policy, when a mixing mode is off, the first application is an application currently in an audio focus, and when the mixing mode is on, the first application is an application currently participating in mixing.

In accordance with another aspect of the disclosure, one or more non-transitory computer-readable storage media storing computer-executable instructions that, when executed by an electronic device, cause the electronic device to perform operations are provided. The operations include triggering, when a preset audio output adjusting event occurs, corresponding views to perform audio output by using matching audio output devices based on a policy that a first application uses a real audio output device and a non-first application uses a virtual audio output device, wherein the audio output adjusting event is an event causing the audio output devices used by the views to not match the policy, when a mixing mode is off, the first application is an application currently in an audio focus, and when the mixing mode is on, the first application is an application currently participating in mixing.

In summary, in the method for audio processing in a multi-view mode provided by the embodiments of the disclosure, a preset audio output adjusting event is monitored. When it is monitored that the event occurs, corresponding views are triggered to perform audio output by using matching sound output devices based on a policy that a first application uses a real sound output device and a non-first application uses a virtual sound output device. The audio output adjusting event is an event causing the sound output devices used by the views to not match the policy. When a mixing mode is off, the first application is an application currently in an audio focus. When the mixing mode is on, the first application is an application currently participating in mixing. In this way, in the multi-view mode, the real sound output device is bound to the application currently in the audio focus or the application currently participating in mixing, whereby the independent output of focus App audios in the multi-view mode can be realized, thereby avoiding an audio resource conflict caused by views newly added.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a schematic diagram of an audio resource conflict according to the related art;

FIG. 2 is a schematic flowchart of a method according to an embodiment of the disclosure;

FIG. 3 is a schematic diagram of a sound output device used in non-focus and focus applications according to an embodiment of the disclosure;

FIG. 4 is a schematic timing diagram of audio processing interactions between an audio controller and an application according to an embodiment of the disclosure;

FIGS. 5, 6, 7, 8, 9, 10, 11, 12, and 13 are schematic diagrams illustrating application scenarios according to various embodiments of the disclosure; and

FIG. 14 is a schematic structural diagram of an apparatus according to an embodiment of the disclosure.

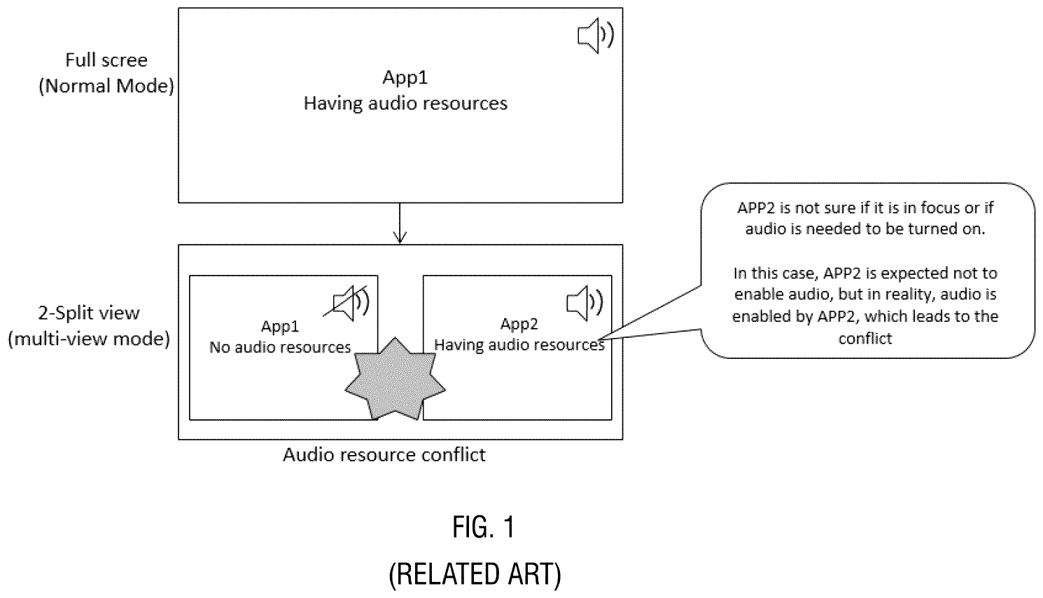

The same reference numerals are used to represent the same elements throughout the drawings.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be appreciated that the blocks in each flowchart and combinations of the flowcharts may be performed by one or more computer programs which include computer-executable instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g., a central processing unit (CPU)), a communication processor (CP, e.g., a modem), a graphical processing unit (GPU), a neural processing unit (NPU) (e.g., an artificial intelligence (AI) chip), a wireless-fidelity (Wi-Fi) chip, a Bluetooth™ chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an IC, or the like.

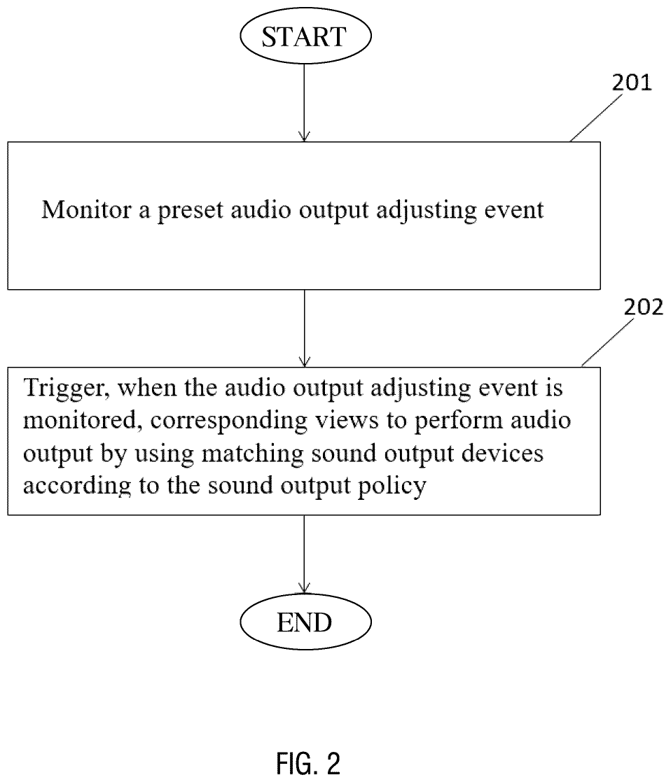

FIG. 2 is a schematic flowchart of a method for audio processing in a multi-view mode according to an embodiment of the disclosure.

Referring to FIG. 2, this embodiment mainly includes the following operations:

Operation 201: Monitor a preset audio output adjusting event.

The audio output adjusting event is an event that causes the sound output device used by a view to not match a preset sound output policy.

The sound output policy is that a first application uses a real sound output device (for example, a real speaker) and a non-first application uses a virtual sound output device.

Specifically, when a mixing mode is off, the first application is an application currently in an audio focus, and when the mixing mode is on, the first application is an application currently participating in mixing.

Operation 201 is configured for monitoring a specified event so as to adjust a sound output device used by a corresponding application in time when the event occurs, whereby each application currently presented uses the sound output device matching the preset sound output policy, thereby always binding the real sound output device to the application currently in the audio focus or the application currently participating in mixing, so as to avoid an audio resource conflict.

In an implementation, the audio output adjusting event may specifically include the following events:

view modes being switched, the audio focus being changed and the mixing mode being off in the multi-view mode, the mixing mode being turned on or off in the multi-view mode, and/or a set of applications participating in mixing being changed.

Operation 202: Trigger, when the audio output adjusting event is monitored, corresponding views to perform audio output by using matching sound output devices according to the sound output policy.

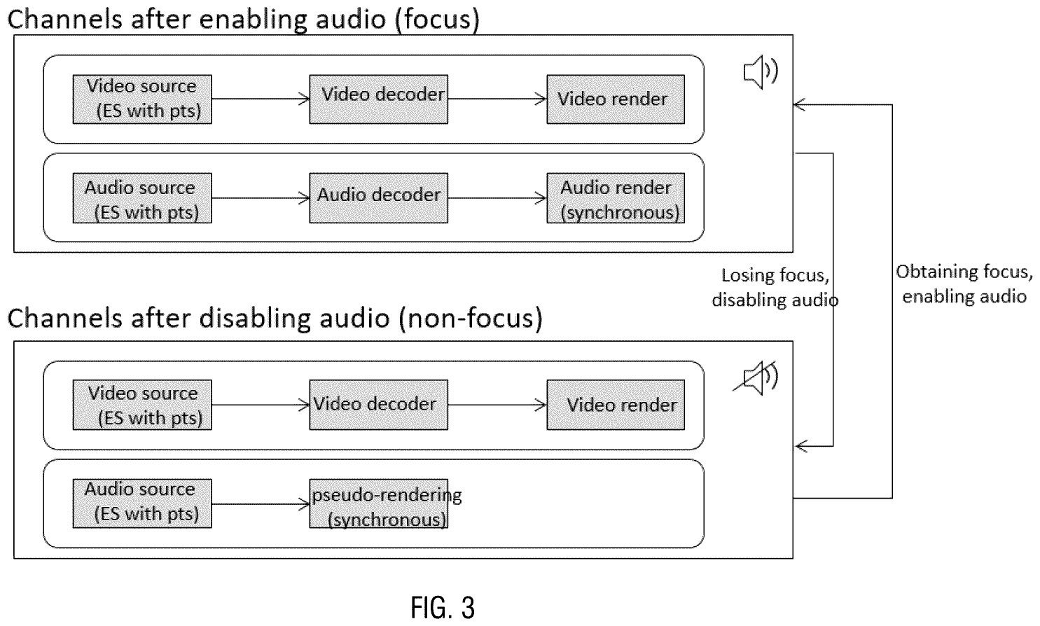

In this operation, switching of corresponding sound output devices is triggered when an event causing a sound output device used by a view to not match the above-mentioned sound output policy is monitored, whereby when an application (App) does not need to play audio, a virtual sound output device is connected thereto, and when App needs to play audio, a real sound output device (namely, an audio decoder and an audio rendering) is connected thereto. Thus, the sound output device to which App is connected switches between the virtual sound output device and the real sound output device (as shown in FIG. 3) along with a focus switching operation of a user, so as to realize the independent audio output of a focus App in a multi-view mode.

FIG. 3 is a schematic diagram of a sound output device used in non-focus and focus applications according to an embodiment of the disclosure.

Referring to FIG. 3, in an implementation, when switching from a single-view mode to the multi-view mode, the corresponding views may be triggered to perform audio output by using matching sound output devices according to the following method:

An application not currently in the audio focus is triggered to perform analog audio output by using the virtual sound output device if the audio focus is not changed before and after starting the multi-view mode. Otherwise, an application currently losing the audio focus is triggered to perform analog audio output by using the virtual sound output device, and then an application currently obtaining the audio focus is triggered to perform audio output by using the real sound output device.

In the above-mentioned method, an application which does not obtain an audio focus needs to be triggered to perform analog audio output by using a virtual sound output device. Thus, an audio synchronization can be realized by analog audio output of the virtual sound output device, whereby the application does not stop playing audio even in a non-audio focus state. In this way, when the application obtains the focus, audio synchronization processing is not required first, thereby reducing the delay of acquiring audio source data and the delay of playing synchronization processing, maintaining the synchronization of audio playing, and realizing seamless audio recovery when the application obtains the focus. Further, seamless audio switching during audio focus switching is realized, and the viewing experience of a user is effectively improved.

In the above-mentioned method, when the audio focus is changed before and after starting, an application currently losing the audio focus needs to be triggered to perform analog audio output by using the virtual sound output device. Then, an application currently obtaining the audio focus is triggered to perform audio output by using the real sound output device. Thus, seamless audio switching during audio focus switching can be realized, and the viewing experience of a user can be effectively improved.

In an implementation, the application may be triggered to perform analog audio output by using the virtual sound output device according to the following method:

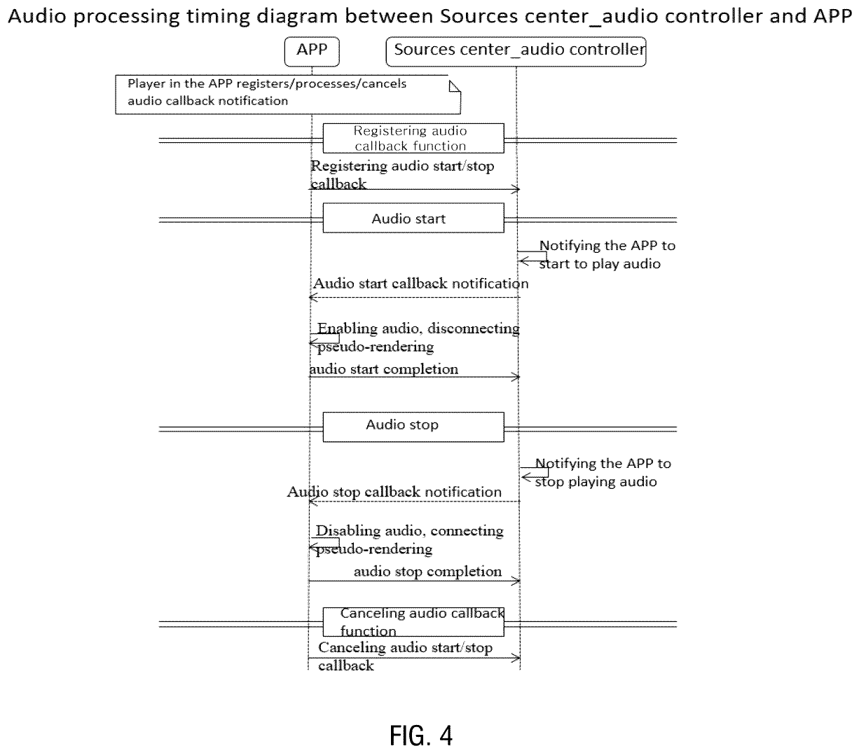

FIG. 4 is a schematic timing diagram of audio processing interactions between an audio controller and an application according to an embodiment of the disclosure.

Referring to FIG. 4, in operation x1: An audio controller transmits an audio stop notification to a corresponding application.

In a specific implementation, referring to FIG. 4, when an application is turned on, a player for the application may register an audio start/stop callback function with the audio controller. If the player for the application no longer needs a callback notification (for example, when the application exits the multi-view mode), the audio start/stop callback function may be logged out of the audio controller. In this way, when the audio controller determines that the application needs to perform analog audio output by using the virtual sound output device based on the currently occurring audio output adjusting event, the audio controller automatically transmits an audio stop callback function thereto for transmitting an audio stop notification. When the audio controller determines that the application needs to perform audio output by using the real sound output device based on the currently occurring audio output adjusting event, the audio controller automatically transmits an audio start callback function thereto for transmitting an audio start notification.

Operation x2: Trigger, in response to the audio stop notification, the application to perform analog audio output by using the virtual sound output device based on audio data received currently, and feedback a corresponding audio stop completion message to the audio controller.

The virtual sound output device is a pseudo-rendering instance having an audio and video synchronization function. That is to say, the virtual sound output device is not the real sound output device, but only the pseudo-rendering instance for realizing audio synchronization through analog audio output.

The audio controller may confirm that the audio stop has been completed based on the audio stop completion message.

In an implementation, in operation x2, analog audio output may be performed by using the virtual sound output device according to the following method:

Operation x21: Block the output of an audio source of an application.

Operation x22: Disconnect, if an audio decoder and an audio rendering instance are connected to the audio source currently, current data channels of the audio decoder and audio rendering instance, and destroy the audio decoder and the audio rendering instance.

If an audio decoder and an audio rendering instance are connected to the audio source currently, it is indicated that the application currently uses the real sound output device. At this moment, the audio source needs to be disconnected from the real sound output device so as to perform analog audio output based on data acquired from the audio source by using the pseudo-rendering instance in a subsequent operation.

Operation x23: Create a pseudo-rendering instance, and perform analog audio output by using the pseudo-rendering instance.

In an implementation, in operation x23, analog audio output may be performed by using the pseudo-rendering instance according to the following method:

Operation a1: Acquire encoded elementary stream (ES) data from an audio source of a corresponding application, where the ES data carries a presentation time stamp (PTS).

Operation a2: Determine, in response to the acquired ES data, whether the presentation time stamp (PTS) carried thereby is less than a running time running_time of a current playing channel, directly discard the ES data if the PTS is less than the running time, otherwise, calculate a difference value between the PTS and running_time, and discard the ES data after waiting for the duration of the difference value.

The running time is an elapsed time that the playing channel is in a playing state.

This operation is used for analog audio output so as to realize audio synchronization. Therefore, when the PTS carried by the ES data is not less than the running time of the current playing channel, the ES data is discarded after waiting for the duration of the corresponding difference value, rather than performing decoding and playing.

a3: Return to operation a1.

In an implementation, the application may be triggered to perform audio output by using the real sound output device according to the following method:

Operation y1: An audio controller transmits an audio start notification to a corresponding application.

In an implementation, as shown in FIG. 4, when the audio controller determines that the application needs to perform audio output by using the real sound output device based on the currently occurring audio output adjusting event, the audio controller transmits an audio start callback function thereto for transmitting an audio start notification.

Operation y2: Trigger, in response to the audio start notification, the application to perform audio output by using the real sound output device based on audio data received currently, and feedback a corresponding audio start completion message to the audio controller.

In an implementation, in operation y2, audio output may be performed by using the real sound output device based on audio data received currently according to the following method:

Operation y21: Block the output of a current audio source of a corresponding application.

Operation y22: Disconnect, if a pseudo-rendering instance is connected to the audio source currently, a data channel of the pseudo-rendering instance, and destroy the pseudo-rendering instance.

Operation y23: Create an audio decoder and an audio rendering instance, and connect the audio source to the audio decoder and the audio rendering instance so as to perform audio output by using the real sound output device based on audio data received currently.

In an implementation, when the audio focus is changed and the mixing mode is not turned on in the multi-view mode, the corresponding views may be triggered to perform audio output by using matching sound output devices according to the following method:

An application currently losing the audio focus is triggered to perform analog audio output by using the virtual sound output device, and then an application currently obtaining the audio focus is triggered to perform audio output by using the real sound output device.

In the above-mentioned method, the specific method for triggering the application to perform analog audio output by using the virtual sound output device is the same as the above-mentioned operations x1-x2, and the specific method for triggering the application to perform audio output by using the real sound output device is the same as the above-mentioned operations y1-y2, which will not be described in detail herein.

In the above-mentioned method, when the audio focus is changed and the mixing mode is not turned on in the multi-view mode, an application currently losing the audio focus needs to be triggered to perform analog audio output by using the virtual sound output device, so as to first release the real sound output device occupied thereby. Then, an application currently obtaining the audio focus is triggered to perform audio output by using the real sound output device. Thus, seamless audio switching during audio focus switching can be realized, and the viewing experience of a user can be effectively improved.

In an implementation, when the mixing mode is turned on in the multi-view mode, the corresponding views may be triggered to perform audio output by using matching sound output devices according to the following method:

An application that currently participates in mixing and is in a non-audio focus is triggered to perform audio output by using the real sound output device.

When the mixing mode is turned off in the multi-view mode, the corresponding views may be triggered to perform audio output by using matching sound output devices according to the following method:

An application that participates in mixing and is in the non-audio focus before the mixing mode is turned off is triggered to perform analog audio output by using the virtual sound output device.

In the above-mentioned method, the specific method for triggering the application to perform analog audio output by using the virtual sound output device is the same as the above-mentioned operations x1-x2, and the specific method for triggering the application to perform audio output by using the real sound output device is the same as the above-mentioned operations y1-y2, which will not be described in detail herein.

In an implementation, when the set of applications participating in mixing is changed, the corresponding views may be triggered to perform audio output by using matching sound output devices according to the following method:

An application currently exiting the set of applications is triggered to perform analog audio output by using the virtual sound output device, and then an application currently newly added to the set of applications is triggered to perform audio output by using the real sound output device.

In the above-mentioned method, the specific method for triggering the application to perform analog audio output by using the virtual sound output device is the same as the above-mentioned operations x1-x2, and the specific method for triggering the application to perform audio output by using the real sound output device is the same as the above-mentioned operations y1-y2, which will not be described in detail herein.

In the above-mentioned method, when the set of applications participating in mixing is changed, an application currently exiting the set of applications needs to be triggered to perform analog audio output by using the virtual sound output device. Then, an application currently newly added to the set of applications is triggered to perform audio output by using the real sound output device. Thus, by releasing the real sound output device first and then allocating the real sound output device, seamless audio switching when the set of applications for mixing is changed can be realized, and the viewing experience of a user can be effectively improved.

In an implementation, when switching from the multi-view mode to a single-view mode, the corresponding views may be triggered to perform audio output by using matching sound output devices according to the following method:

An application currently required to exit presentation is triggered to release the real sound output device if the application currently required to exit presentation uses the real sound output device to perform audio output before it exits, or the application currently required to exit presentation is triggered to perform analog audio output by using the virtual sound output device.

In the above-mentioned method, the specific method for triggering the application to perform analog audio output by using the virtual sound output device is the same as the above-mentioned operations x1-x2, and the specific method for triggering the application to perform audio output by using the real sound output device is the same as the above-mentioned operations y1-y2, which will not be described in detail herein.

It can be seen from the above-mentioned technical solutions that according to the above-mentioned method embodiments of the disclosure, in the multi-view mode, the real sound output device may always be bound to the application currently in the audio focus or the application currently participating in mixing, whereby the independent output of focus App audios in the multi-view mode can be realized, thereby avoiding an audio resource conflict caused by views newly added. In addition, an application which does not obtain an audio focus performs analog audio output by using a virtual sound output device to realize audio synchronization, thereby realizing seamless audio recovery when the application obtains the focus. Further, seamless audio switching during audio focus switching is realized, and the viewing experience of a user is effectively improved.

Specific implementations of the above-mentioned method embodiments are exemplified below in conjunction with several specific application scenarios. In the following scenarios, an audio controller is arranged in a resource center, and a multi-view App provides the audio controller with information, such as an audio focus and a mixing mode, so as to monitor a preset audio output adjusting event.

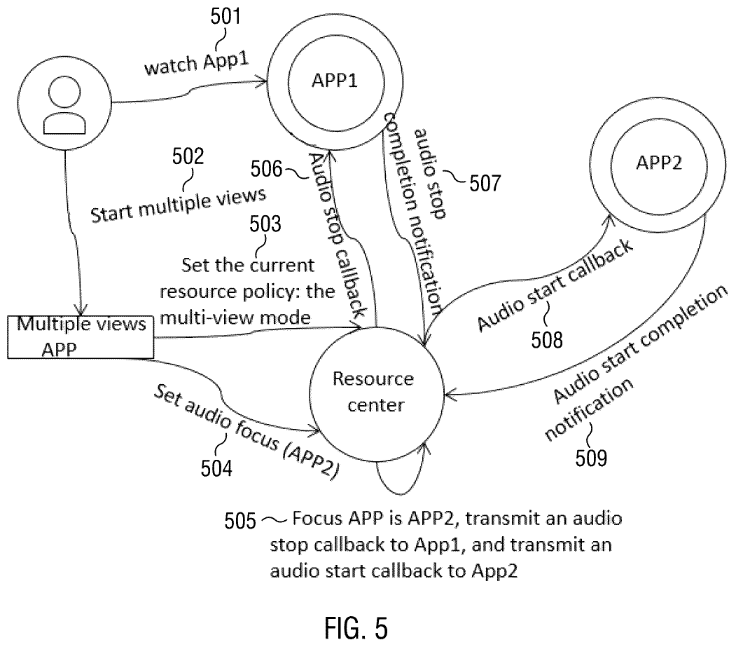

FIGS. 5, 6, 7, 8, 9, 10, 11, 12, and 13 are schematic diagrams illustrating application scenarios according to various embodiments of the disclosure.

Scenario 1: Enter a multi-view mode from a single-view mode. Referring to FIG. 5, audio processing in this scenario may be realized by using the following operations:

Operation 501: In the single-view mode, a user is watching App1 over a full screen, and App1 outputs audio.

Operation 502: The user starts multiple views via the multi-view App, where Apps in the multiple views are App1 and App2.

Operation 503: The multi-view App sets a current resource policy as the multi-view mode for the resource center.

Operation 504: The multi-view App sets the audio focus as App2 for the resource center.

Operation 505: According to the setting of the multi-view App, the resource center obtains that App1 should stop audio output, and App2 should perform audio output.

Operation 506: The resource center transmits an audio stop callback to App1, and App1 stops audio output.

Operation 507: App1 transmits an audio stop completion notification to the resource center.

Operation 508: The resource center transmits an audio start callback to App2, and App2 starts audio output.

Operation 509: App2 transmits an audio start complete notification to the resource center.

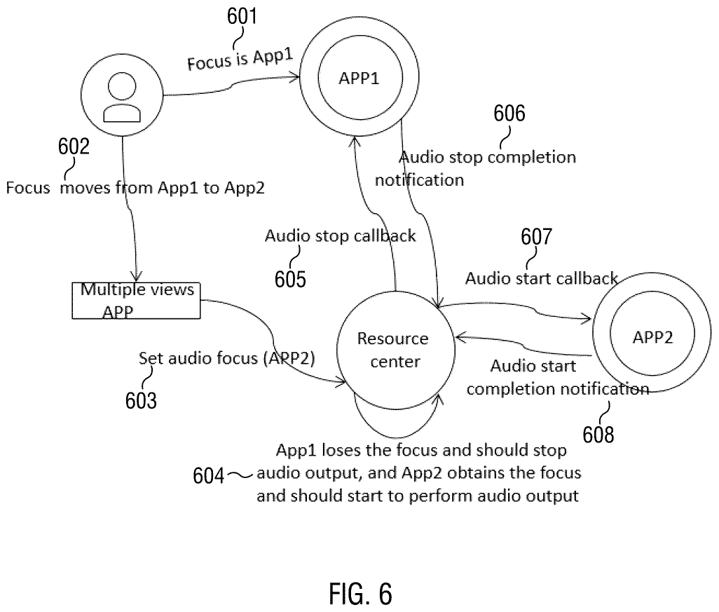

Scenario 2: Audio focus switching in a multi-view mode. Referring to FIG. 6, audio processing in this scenario may be realized by using the following operations:

Operation 601: In the multi-view mode, a user focuses on App1, and App1 outputs audio.

Operation 602: The user moves the focus through the multi-view App, and the focus moves from App1 to App2.

Operation 603: The multi-view App sets the audio focus as App2 for the resource center.

Operation 604: According to the setting of the multi-view App, the resource center obtains that App1 loses the focus and should stop audio output, and App2 obtains the focus and should perform audio output.

Operation 605: The resource center transmits an audio stop callback to App1, and App1 stops audio output.

Operation 606: App1 transmits an audio stop completion notification to the resource center.

Operation 607: The resource center transmits an audio start callback to App2, and App2 starts audio output.

Operation 608: App2 transmits an audio start complete notification to the resource center.

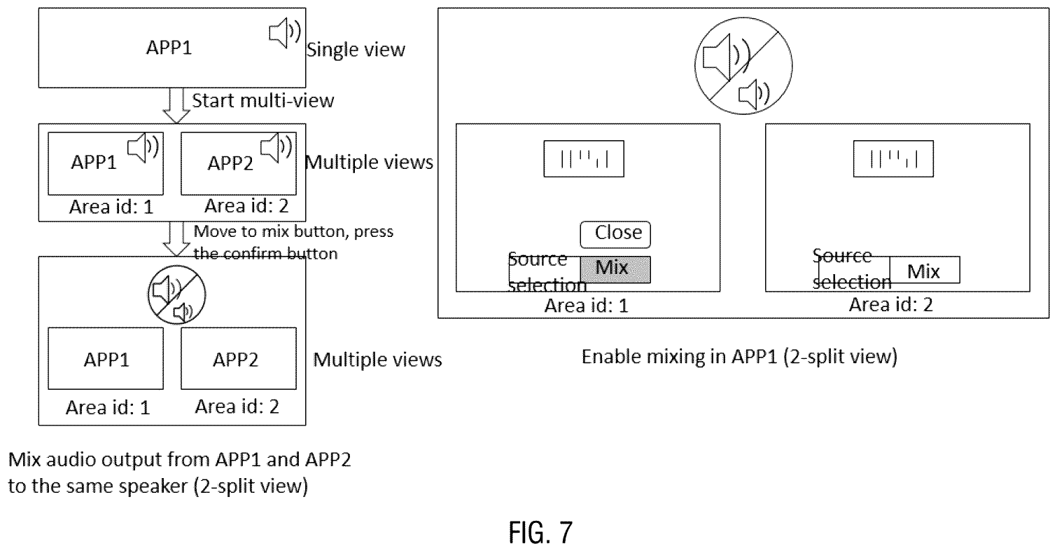

Scenario 3: Start a mixing mode in a multi-view mode. Referring to FIG. 7, either a left or right APP may enable mixing. After an audio on a non-focus side is mixed, a real speaker will be used for output. For example, the audio of two APPs is mixed and then output to the same speaker.

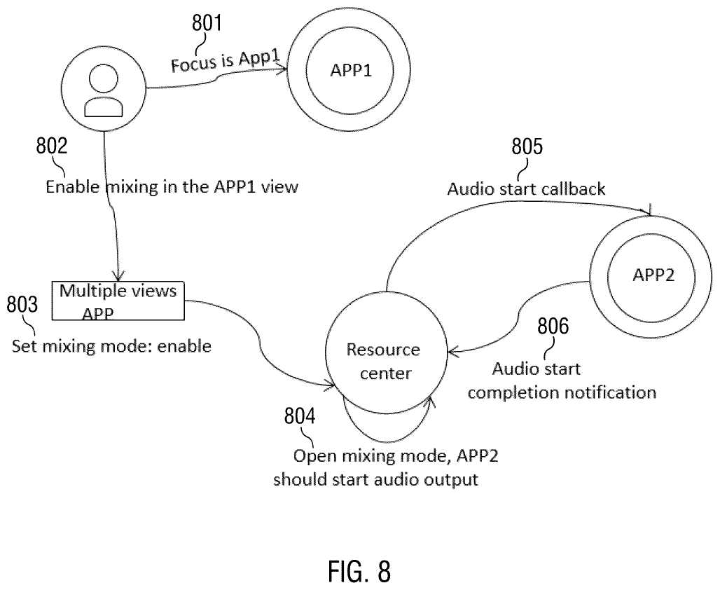

Referring to FIG. 8, when the mixing mode is enabled in the scenario shown in FIG. 7, audio processing in this scenario may be realized by using the following operations:

Operation 801: In the multi-view mode, a user focuses on App1, and App1 outputs audio.

Operation 802: The user enables the mixing mode in an App1 view via the multi-view App.

Operation 803: The multi-view App sets the mixing mode to be enabled for the resource center.

Operation 804: According to the setting of the multi-view App, the resource center obtains that App2 should start audio and output the audio mixed with the audio of App1.

Operation 805: The resource center transmits an audio start callback to App2, and App2 starts audio output.

Operation 806: App2 transmits an audio start complete notification to the resource center.

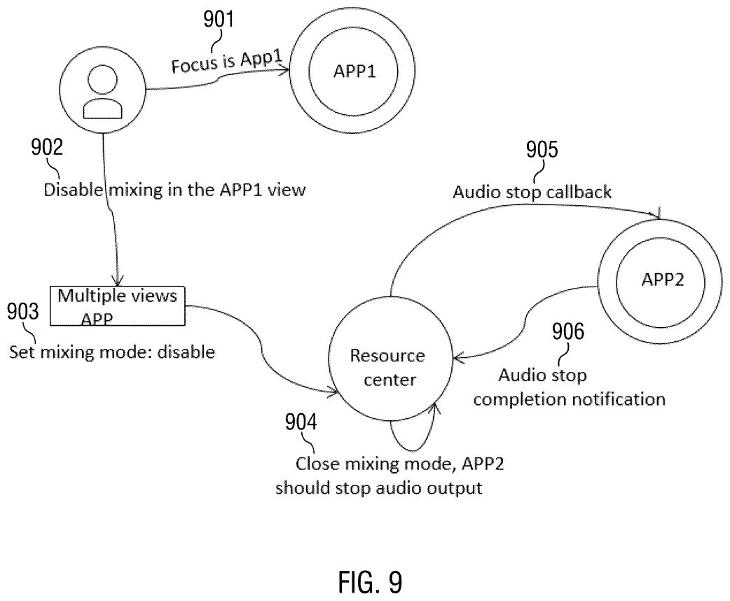

Scenario 4: Turn off a mixing mode in a multi-view mode (namely, set the mixing mode to be disabled). Referring to FIG. 9, when the mixing mode is turned off, audio processing in this scenario may be realized by using the following operations:

Operation 901: In the multi-view mode, a user focuses on App1, the mixing mode is enabled, and audios of App1 and App2 are output after being mixed.

Operation 902: The user disables the mixing mode in an App1 view via the multi-view App.

Operation 903: The multi-view App sets the mixing mode to be disabled for the resource center.

Operation 904: According to the setting of the multi-view App and the current focus being App1, the resource center obtains that App2 should stop audio output.

Operation 905: The resource center transmits an audio stop callback to App2, and App2 stops audio output.

Operation 906: App2 transmits an audio stop complete notification to the resource center.

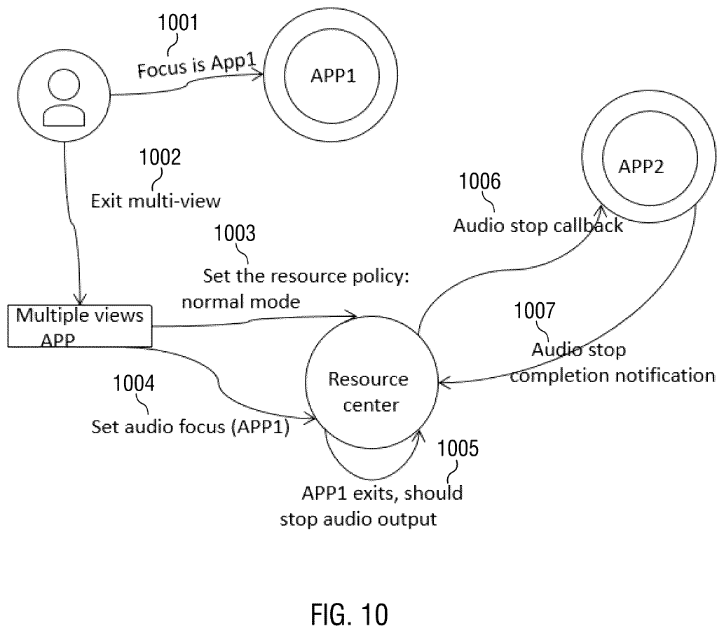

Scenario 5: Enter a single-view mode from a multi-view mode. Referring to FIG. 10, when the multi-view mode is exited, audio processing in this scenario may be realized by using the following operations:

Operation 1001. In the multi-view mode, a user focuses on App1, the mixing mode is enabled, and audios of App1 and App2 are output after being mixed.

Operation 1002. The user disables the mixing mode in an App1 view via the multi-view App.

Operation 1003. The multi-view App sets the mixing mode to be disabled for the resource center.

Operation 1004. According to the setting of the multi-view App and the current focus being App1, the resource center sets audio focus App1, and in operation 1005, obtains that App2 should stop audio output.

Operation 1006. The resource center transmits an audio stop callback to App2, and App2 stops audio output.

Operation 1007. App2 transmits an audio stop complete notification to the resource center.

The independent output of focus App audios in the multi-view mode that can be realized by embodiments of the disclosure is exemplified below through Scenarios 6 to 8.

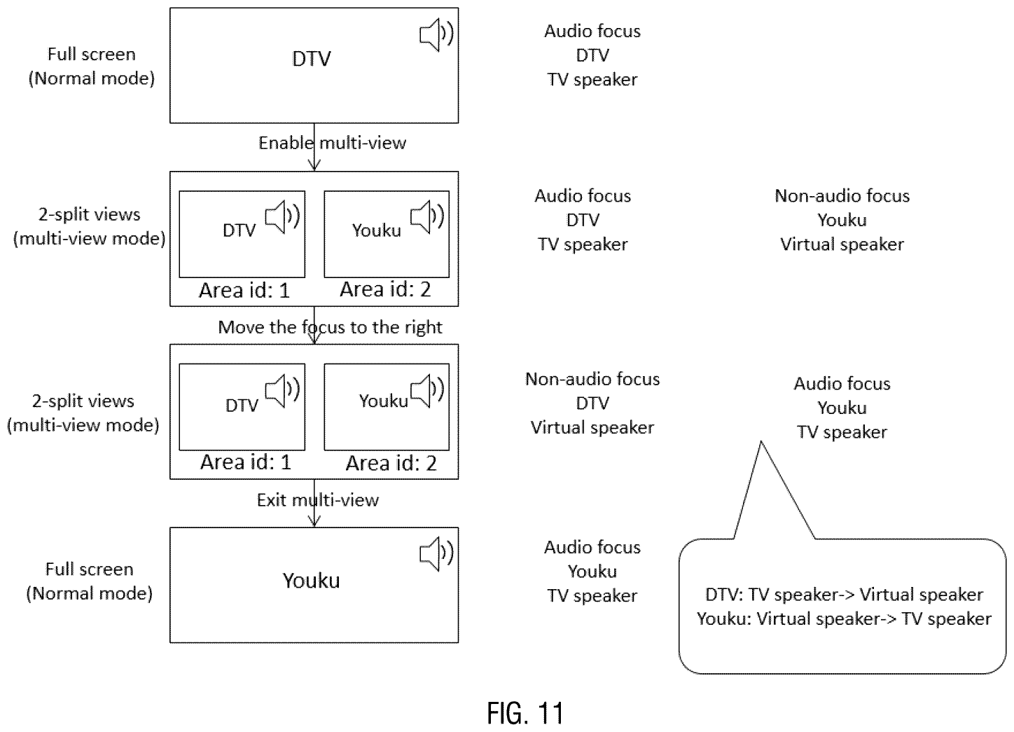

Referring to FIG. 11, in Scenario 6, when entering the multi-view mode, an application always in an audio focus uses a TV speaker. When the multi-view mode is enabled, a newly added application Youku uses a virtual speaker. In the multi-view mode, when the audio focus switches from DTV to Youku, Youku will use the TV speaker, while DTV switches to use the virtual speaker. When the multi-view mode is exited, the audio focus Youku still uses the TV speaker.

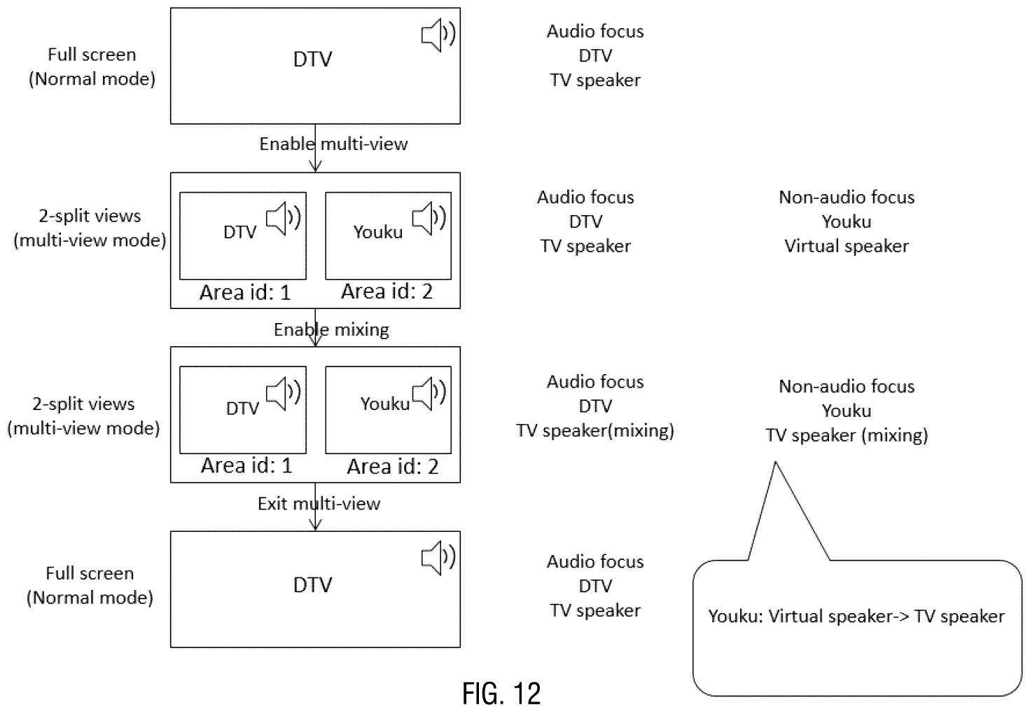

Referring to FIG. 12, in the multi-view mode, when the mixing mode is enabled, APPs participating in mixing will use the TV speaker. For example, the non-audio focus Youku will also switch to use the TV speaker.

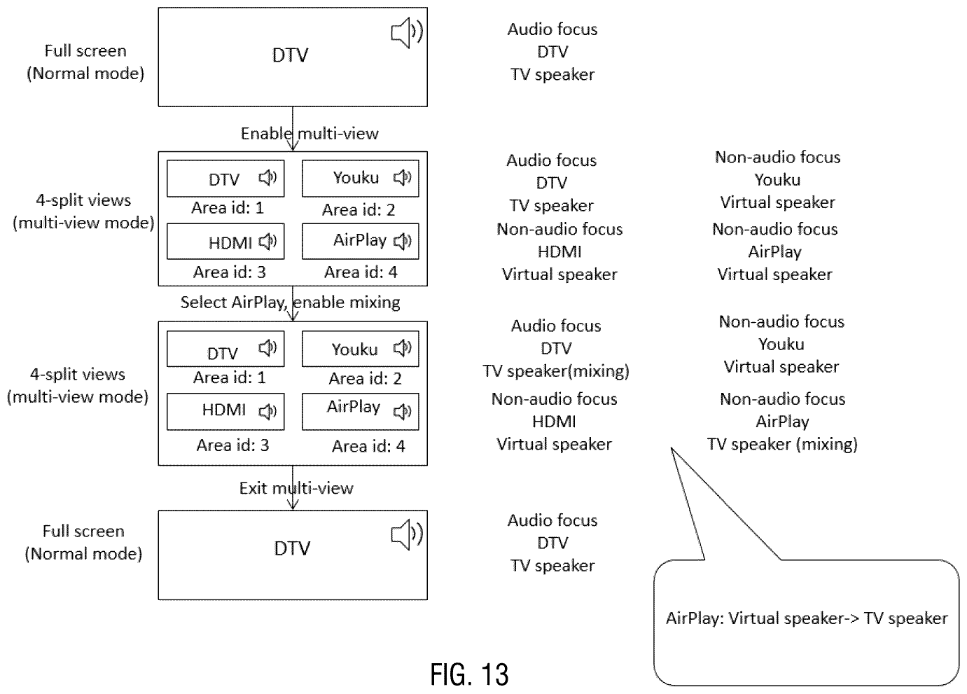

Referring to FIG. 13, in the multi-view mode, when the mixing mode is enabled and only a non-audio focus AirPlay is selected to participate in mixing, the non-audio focus AirPlay switches to use the TV speaker.

From Scenarios 6 to 8, it can be seen that with the embodiments of the disclosure, the real sound output device is always bound to the application currently in the audio focus or the application currently participating in mixing, whereby the independent output of focus App audios can be realized, thereby avoiding the problem of an audio resource conflict.

Based on the above-mentioned method embodiments of the disclosure, embodiments of the disclosure accordingly also provide an apparatus for audio processing in a multi-view mode.

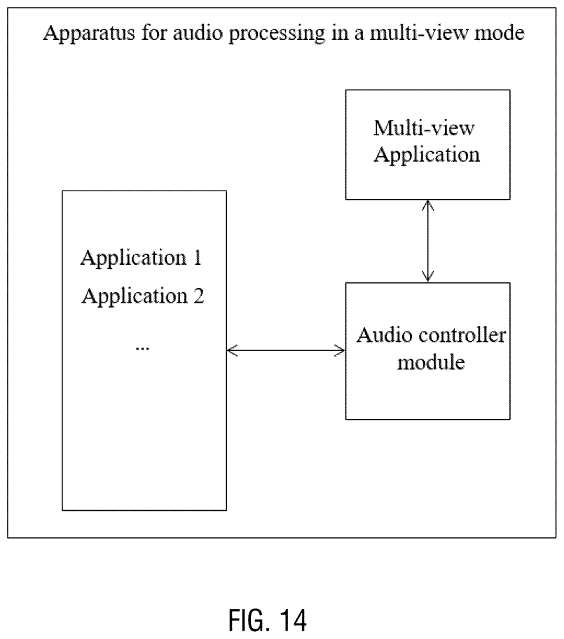

FIG. 14 is a schematic structural diagram of an apparatus according to an embodiment of the disclosure.

Referring to FIG. 14, the apparatus includes:
an audio controller module, configured to trigger, when a preset audio output adjusting event occurs, corresponding views to perform audio output by using matching sound output devices based on a policy that a first application uses a real sound output device and a non-first application uses a virtual sound output device.

The audio output adjusting event is an event causing the sound output devices used by the views to not match the policy, when a mixing mode is off, the first application is an application currently in an audio focus, and when the mixing mode is on, the first application is an application currently participating in mixing.

Based on the above-mentioned method embodiments of the disclosure, embodiments of the disclosure accordingly also provide an electronic device for audio processing in a multi-view mode, including a processor and memory. The memory has an application executable by the processor stored therein for causing the processor to perform the method for audio processing in a multi-view mode as mentioned above. Specifically, a system or apparatus with a storage medium may be provided. A software program code that realizes the functions of any one implementation in the above-mentioned embodiments is stored on the storage medium, and a computer (or a CPU or an MPU) of the system or apparatus is caused to read out and execute the program code stored in the storage medium. Furthermore, some or all of actual operations may be completed by an operating system or the like operating on the computer through instructions based on the program code. The program code read out from the storage medium may also be written into memory provided in an expansion board inserted into the computer or into memory provided in an expansion unit connected to the computer. Then, an instruction based on the program code causes a CPU or the like installed on the expansion board or the expansion unit to perform some or all of the actual operations, so as to realize the functions of any one of the implementations of the above-mentioned method for audio processing in a multi-view mode.

The memory may be specifically implemented as various storage media, such as electrically erasable programmable read-only memory (EEPROM), flash memory, and programmable program read-only memory (PROM). The processor may be implemented as including one or more central processing units or one or more field programmable gate arrays. The field programmable gate arrays are integrated with one or more central processing unit cores. Specifically, the central processing unit or central processing unit core may be implemented as a CPU or an MCU.

Embodiments of this application implement a computer program product including computer programs/instructions which, when executed by a processor, implement the operations of the method for audio processing in a multi-view mode as mentioned above.

It should be noted that not all the operations and modules in the above-mentioned flowcharts and structural diagrams are necessary, and some operations or modules may be omitted according to actual requirements. The order of execution of the operations is not fixed and may be adjusted as required. The division of various modules is merely to facilitate the description of the functional division adopted. In an actual implementation, one module may be divided into a plurality of modules, the functions of the plurality of modules may also be realized by the same module, and these modules may be located in the same device or in different devices.

Hardware modules in various implementations may be implemented mechanically or electronically. For example, one hardware module may include a specially designed permanent circuit or logic device (for example, a dedicated processor, such as a field-programmable gate array (FPGA) or an application-specific integrated circuit (ASIC)) for performing a particular operation. The hardware module may also include a programmable logic device or circuit (for example, including a general purpose processor or other programmable processors) temporarily configured by software for performing a particular operation. The implementation of the hardware module mechanically, or using a dedicated permanent circuit, or using a temporarily configured circuit (for example, configured by software) may be determined based on cost and time considerations.

As used herein, “schematic” means “serving as an instance, example, or illustration”, and any illustration and implementation mode described herein as “schematic” should not be construed as a more preferred or advantageous technical solution. For sake of clarity of the drawings, only portions of the drawings related to the disclosure are schematically shown and are not representative of an actual structure of the product. In addition, for simplicity and ease of understanding, only one of components having the same structure or function is schematically drawn or marked in some figures. As used herein, “one” does not mean to limit the number of related portions of the disclosure to “only one”, and “one” does not mean to exclude the case that the number of related portions of the disclosure is “more than one”. As used herein, “upper”, “lower”, “front”, “back”, “left”, “right”, “inner”, “outer”, and the like are used merely to indicate relative positional relationships between related portions, and do not limit absolute positions of these related portions.

The solutions described in this description and the embodiments of the disclosure, if involving personal information processing, will be processed on the premise of legality (for example, obtaining the consent of a personal information subject, or necessary for the performance of a contract), and will only be processed within the specified or agreed scope. A user refuses to process personal information other than the information necessary to basic functions, and the basic functions used by the user will not be affected.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method for audio processing in a multi-view mode, the method comprising:
triggering, when a preset audio output adjusting event occurs, corresponding views to perform audio output by using matching audio output devices based on a policy that a first application uses a real audio output device and a non-first application uses a virtual audio output device,
wherein the audio output adjusting event is an event causing the audio output devices used by the views to not match the policy, when a mixing mode is off, the first application is an application currently in an audio focus, and when the mixing mode is on, the first application is an application currently participating in mixing.

2. The method of claim 1, wherein the audio output adjusting event comprises view modes being switched, the audio focus being changed and the mixing mode being off in the multi-view mode, the mixing mode being turned on or off in the multi-view mode, and/or a set of applications participating in mixing being changed.

3. The method of claim 2, wherein, when switching from a single-view mode to the multi-view mode, the triggering corresponding views to perform audio output by using matching audio output devices comprises:
triggering an application not currently in the audio focus to perform analog audio output by using the virtual audio output device if the audio focus is not changed before and after starting the multi-view mode; otherwise,
triggering an application currently losing the audio focus to perform analog audio output by using the virtual audio output device; and
triggering an application currently obtaining the audio focus to perform audio output by using the real audio output device.

4. The method of claim 2, wherein, when the audio focus is changed and the mixing mode is not turned on in the multi-view mode, the triggering corresponding views to perform audio output by using matching audio output devices comprises:
triggering an application currently losing the audio focus to perform analog audio output by using the virtual audio output device; and
triggering an application currently obtaining the audio focus to perform audio output by using the real audio output device.

5. The method of claim 2,
wherein, when the mixing mode is turned on in the multi-view mode, the triggering corresponding views to perform audio output by using matching audio output devices comprises:
triggering an application that currently participates in mixing and is in a non-audio focus to perform audio output by using a real sound output device, and
wherein, when the mixing mode is turned off in the multi-view mode, the triggering corresponding views to perform audio output by using matching sound output devices comprises:
triggering an application that participates in mixing and is in the non-audio focus before the mixing mode is turned off to perform analog audio output by using a virtual sound output device.

6. The method of claim 5, wherein, when the set of applications participating in mixing is changed, the triggering corresponding views to perform audio output by using matching sound output devices comprises:
triggering an application currently exiting the set of applications to perform analog audio output by using the virtual sound output device; and
triggering an application currently newly added to the set of applications to perform audio output by using the real sound output device.

7. The method of claim 5, wherein, when switching from the multi-view mode to a single-view mode, the triggering corresponding views to perform audio output by using matching sound output devices comprises:
triggering an application currently required to exit presentation to release the real sound output device if the application currently required to exit presentation uses the real sound output device to perform audio output before it exits, or triggering the application currently required to exit presentation to perform analog audio output by using the virtual sound output device.

8. The method of claim 5, wherein the triggering of the application to perform analog audio output by using the virtual sound output device comprises:
transmitting, by an audio controller, an audio stop notification to a corresponding application; and
triggering, in response to the audio stop notification, the application to perform analog audio output by using the virtual sound output device based on audio data received currently, and feeding back a corresponding audio stop completion message to the audio controller, wherein the virtual sound output device is a pseudo-rendering instance having an audio and video synchronization function.

9. The method of claim 8, wherein the performing of the analog audio output by using the virtual sound output device based on audio data received currently comprises:
blocking an output of a current audio source;
disconnecting, if an audio decoder and an audio rendering instance are connected to the audio source currently, current data channels of the audio decoder and audio rendering instance, and destroying the audio decoder and the audio rendering instance; and
creating the pseudo-rendering instance, and performing analog audio output by using the pseudo-rendering instance.

10. The method of claim 9, wherein the performing of the analog audio output by using the pseudo-rendering instance comprises:
acquiring encoded elementary stream (ES) data from an audio source of a corresponding application, the ES data carrying a presentation time stamp (PTS); and
determining, in response to the acquired ES data, whether the PTS carried thereby is less than a running time running_time of a current playing channel, directly discarding the ES data if the PTS is less than the running time, otherwise, calculating a difference value between the PTS and running_time, and discarding the ES data after waiting for a duration of the difference value.

11. The method of claim 5, wherein the triggering of the application to perform audio output by using the real sound output device comprises:
transmitting, by an audio controller, an audio start notification to a corresponding application; and
triggering, in response to the audio start notification, the application to perform audio output by using the real sound output device based on audio data received currently, and feeding back a corresponding audio start completion message to the audio controller.

12. The method of claim 11, wherein the triggering of the application to perform audio output by using the real sound output device based the on audio data received currently comprises:
blocking an output of a current audio source;
disconnecting, if a pseudo-rendering instance is connected to the audio source currently, a data channel of the pseudo-rendering instance, and destroying the pseudo-rendering instance; and
creating an audio decoder and an audio rendering instance, and connecting the audio source to the audio decoder and the audio rendering instance so as to perform audio output by using the real sound output device based on audio data received currently.

13. An apparatus for audio processing in a multi-view mode, the apparatus comprising:
an audio controller module, configured to trigger, when a preset audio output adjusting event occurs, corresponding views to perform audio output by using matching sound output devices based on a policy that a first application uses a real sound output device and a non-first application uses a virtual sound output device,
wherein the audio output adjusting event is an event causing the sound output devices used by the views to not match the policy, when a mixing mode is off, the first application is an application currently in an audio focus, and when the mixing mode is on, the first application is an application currently participating in mixing.

14. An electronic device for audio processing in a multi-view mode, the electronic device comprising:
memory storing one or more computer programs; and
one or more processors communicatively coupled to the memory,
wherein the one or more computer programs include computer-executable instructions that, when executed by the one or more processors, cause the electronic device to:
trigger, when a preset audio output adjusting event occurs, corresponding views to perform audio output by using matching audio output devices based on a policy that a first application uses a real audio output device and a non-first application uses a virtual audio output device, and
wherein the audio output adjusting event is an event causing the audio output devices used by the views to not match the policy, when a mixing mode is off, the first application is an application currently in an audio focus, and when the mixing mode is on, the first application is an application currently participating in mixing.

15. The electronic device of claim 14, wherein the audio output adjusting event comprises view modes being switched, the audio focus being changed and the mixing mode being off in the multi-view mode, the mixing mode being turned on or off in the multi-view mode, and/or a set of applications participating in mixing being changed.

16. The electronic device of claim 15, wherein the one or more computer programs further include computer-executable instructions that, when executed by the one or more processors, cause the electronic device to:
trigger an application not currently in the audio focus to perform analog audio output by using the virtual audio output device if the audio focus is not changed before and after starting the multi-view mode; otherwise,
trigger an application currently losing the audio focus to perform analog audio output by using the virtual audio output device, and
trigger an application currently obtaining the audio focus to perform audio output by using the real audio output device.

17. The electronic device of claim 15, wherein the one or more computer programs further include computer-executable instructions that, when executed by the one or more processors, cause the electronic device to:
trigger an application currently losing the audio focus to perform analog audio output by using the virtual audio output device, and
trigger an application currently obtaining the audio focus to perform audio output by using the real audio output device.

18. The electronic device of claim 15, wherein the one or more computer programs further include computer-executable instructions that, when executed by the one or more processors, cause the electronic device to:
trigger an application that currently participates in mixing and is in a non-audio focus to perform audio output by using a real sound output device, and
trigger an application that participates in mixing and is in the non-audio focus before the mixing mode is turned off to perform analog audio output by using a virtual sound output device.

19. One or more non-transitory computer-readable storage media storing computer-executable instructions that, when executed by an electronic device, cause the electronic device to perform operations, the operations comprising:
triggering, when a preset audio output adjusting event occurs, corresponding views to perform audio output by using matching audio output devices based on a policy that a first application uses a real audio output device and a non-first application uses a virtual audio output device,
wherein the audio output adjusting event is an event causing the audio output devices used by the views to not match the policy, when a mixing mode is off, the first application is an application currently in an audio focus, and when the mixing mode is on, the first application is an application currently participating in mixing.

20. The one or more non-transitory computer-readable storage media of claim 19, wherein the audio output adjusting event comprises view modes being switched, the audio focus being changed and the mixing mode being off in a multi-view mode, the mixing mode being turned on or off in the multi-view mode, and/or a set of applications participating in mixing being changed.
